(19) United States
(12) Patent Application Publication
(10) Pub. No.: US 2012/0044157 A1
(43) Pub. Date: Feb. 23, 2012

(54) IMAGE BASED CONTROL METHOD, PROCESSING METHOD, AND SYSTEM

(75) Inventor: Yu Jen Chen, Taipei County (TW)

(73) Assignee: AMTRAN TECHNOLOGY CO., LTD, Taipei County (TW)

(21) Appl. No.: 12/899,341

(22) Filed: Oct. 6, 2010

(30) Foreign Application Priority Data
Aug. 20, 2010 (TW) 099128027

(51) Int. Cl. G06F 3/041

(52) U.S. Cl. 345/173

(57) ABSTRACT

An image based control method and a image based processing method are applicable to a system including a controller and a terminal device. The control method includes the steps of receiving a selected image and displaying the selected image on a touch screen of the controller, in which the selected image is corresponding to a window-of-interest (WOI) of a terminal screen of the terminal device; receiving a user command corresponding to the selected image through the touch screen; and transferring a control command to the terminal device according to the user command for controlling the terminal device.

### CROSS-REFERENCE TO RELATED APPLICATIONS

This non-provisional application claims priority under 35 U.S.C. §119(a) on Patent Application No(s). 099128027 filed in Taiwan, R.O.C. on Aug. 20, 2010, the entire contents of which are hereby incorporated by reference.

### BACKGROUND OF THE INVENTION

1. Field of the Invention

The present invention relates to a control method, a processing method, and a system, and more particularly to an image based control method, a processing method, and a system.

2. Related Art

Presently, it becomes increasingly popular that household appliances serve as terminal devices and then are combined with multimedia application devices. For example, the household appliance, such as a television set, may be combined with different functions, such as a Digital Video Disk (DVD) player, a Blue-ray disk player, an audio device, a game machine, or a web browser. However, conventionally, each multimedia application device needs a dedicated controller, which brings the user troubles of a complex and easily confused control method.

Even when a plurality of controllers is integrated into one controller to control a terminal device having multiple multimedia functions, the integrated controller still has many problems. For example, a plurality of keys representing different signal functions needs to be arranged on the controller, but the multitudinous keys not only occupy the space, but also easily cause confusing to the user. Especially, for a television set having a web browser function or a game function, besides an original controller, a mouse needs to be used in cooperation, so as to meet a demand for controlling a cursor. The additional mouse adds the hardware cost, and the cooperating operation mode is very complex.

That is to say, the conventional terminal devices having multiple multimedia functions have the disadvantages of requiring several control devices, a high cost, and inconvenient and complex control modes.

### SUMMARY OF THE INVENTION

Accordingly, the present invention is related to an image based control method, a processing method, and a system. The image based control method and the image based processing method are applicable to a controller and a terminal device with a terminal screen of the image based control system.

The present invention provides an image based control method, which is executed on the controller and comprises: receiving a selected image and displaying the selected image on a touch screen of the controller, in which the selected image is corresponding to a window-of-interest (WOI) of a terminal screen of a terminal device; receiving a user command corresponding to the selected image through the touch screen; and transferring a control command to the terminal device according to the user command, to control the terminal device.

The user command may comprise a click command, and the control command comprises a click coordinate corresponding to the selected image. The image based control method may further comprise: letting the terminal device open a click hyperlink according to the click coordinate.

The user command may further comprise a move command, and the control command comprises a moving direction. The image based control method may further comprise: letting the terminal device move the WOI according to the moving direction; and receiving the selected image corresponding to the moved WOI, and displaying the moved selected image on the touch screen. Images corresponding to the WOI and the moved WOI may partially overlap.

The user command may further comprise a reducing command, and the image based control method may further comprise: letting the terminal device enlarge the WOI according to the reducing command, to obtain the selected image with reduced content; and receiving the selected image with reduced content corresponding to the enlarged WOI, and displaying the selected image with reduced content on the touch screen.

The user command may further comprise an enlarging command, and the image based control method may further comprise: letting the terminal device reduce the WOI according to the enlarging command, to obtain the selected image with enlarged content; and receiving the selected image with enlarged content corresponding to the reduced WOI, and displaying the selected image with enlarged content on the touch screen.

Furthermore, the image based control method may further comprise: receiving a markup language information corresponding to the WOI, and displaying the markup language information on the touch screen, in which the markup language information comprises at least one hyperlink tag.

When the user command is a click command, the control command may be the clicked hyperlink tag. The image based control method may further comprise: letting the terminal device open a click hyperlink according to the clicked hyperlink tag. The touch screen displays the hyperlink tag through a highlighted mark.

The present invention also provides an image based processing method, which is executed on the terminal device and comprises: setting the WOI on the terminal screen; transferring the selected image corresponding to the WOI to the controller, such that a touch screen of the controller displays the selected image; receiving the control command, in which the control command is corresponding to the user command received by the controller through the touch screen; and processing the terminal screen according to the control command.

The present invention further provides an image based control system, which comprises the terminal device and the controller. The terminal device comprises the terminal screen, has the WOI set on the terminal screen, and transfers the selected image corresponding to the WOI. The controller comprises the touch screen, receives the selected image from the terminal device, displays the selected image on the touch screen, receives the user command corresponding to the selected image through the touch screen, and transfers the control command to the terminal device according to the user command to control the terminal device. After receiving the control command, the terminal device processes the terminal screen according to the control command.

In view of the above, through the image based control method, the processing method, and the system, the user may manipulate the terminal device in a relaxed and intuitive way merely by using a single controller.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a schematic view of an image based control system according to an embodiment;

FIG. 2 is a flow chart of an image based processing method according to an embodiment;

FIG. 3 is a flow chart of an image based control method according to an embodiment;

FIG. 4 is a schematic view of a moved WOI and a display according to an embodiment;

FIG. 5 is a schematic view of overlapped WOIs according to an embodiment;

FIG. 6 is a schematic view of an enlarged WOI and a display according to an embodiment;

FIG. 7 is a schematic view of a reduced WOI and a display according to an embodiment; and

FIG. 8 is a schematic view of a highlighted mark according to an embodiment.

### DETAILED DESCRIPTION OF THE INVENTION

The detailed features and advantages of the present invention are described below in great detail through the following embodiments, and the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention.

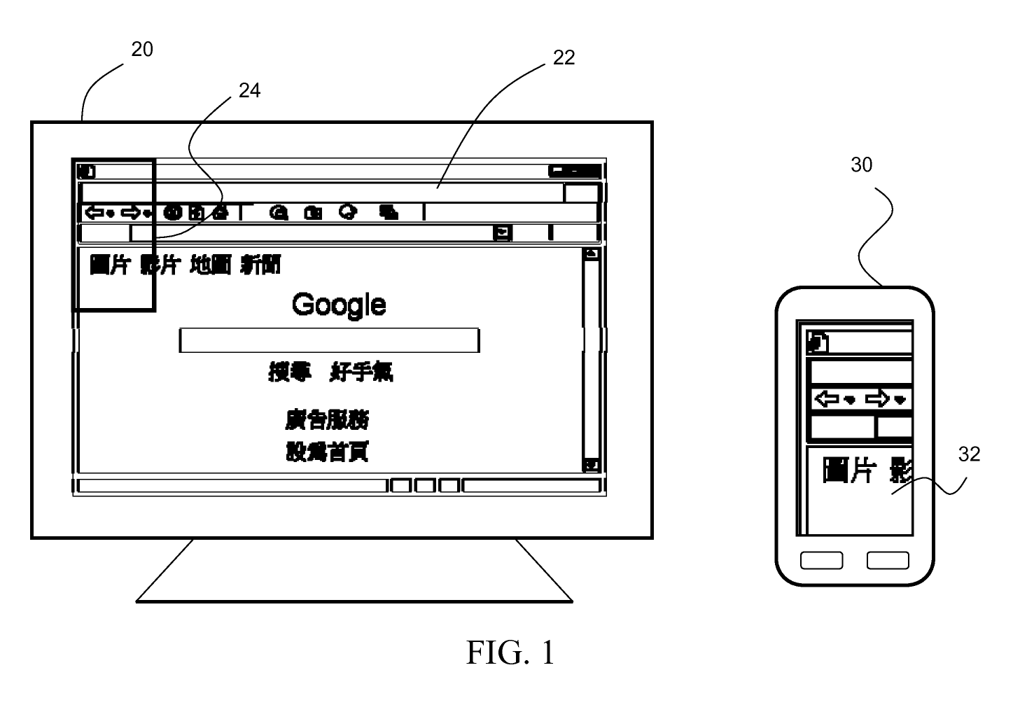

An image based control method and an image based processing method according to the present invention are applicable to an image based control system, in which the image based control system comprises a terminal device and a controller used to control the terminal device. FIG. 1 is a schematic view of an image based control system according to an embodiment.

Referring to FIG. 1, the terminal device 20 comprises a terminal screen 22. The terminal device 20 is, for example, a television set or a display of a computer, and a projector and a frame projected by the projector may also be considered as the terminal device 20 and the terminal screen 22. The terminal device 20 may execute application programs, for example, Video on Demand (VOD) players for watching television programs, web browsers, or electronic games.

The controller 30 comprises a touch screen 32, such that the user may control the terminal device 20 in a more intuitive and simpler way through the touch screen 32. The touch screen 32 only needs to support single touch, but may also support multi-touch to provide more convenient user experiences. The controller 30 further comprises necessary hardware (not shown) capable of executing the image based control method, such as, a processor. The controller 30 may also comprise other keys for assisting operation. Furthermore, data may be transferred between the terminal device 20 and the controller 30 through a radio transmission interface, such as Wireless Fidelity (Wi-Fi), Radio Frequency (RF), or Bluetooth.

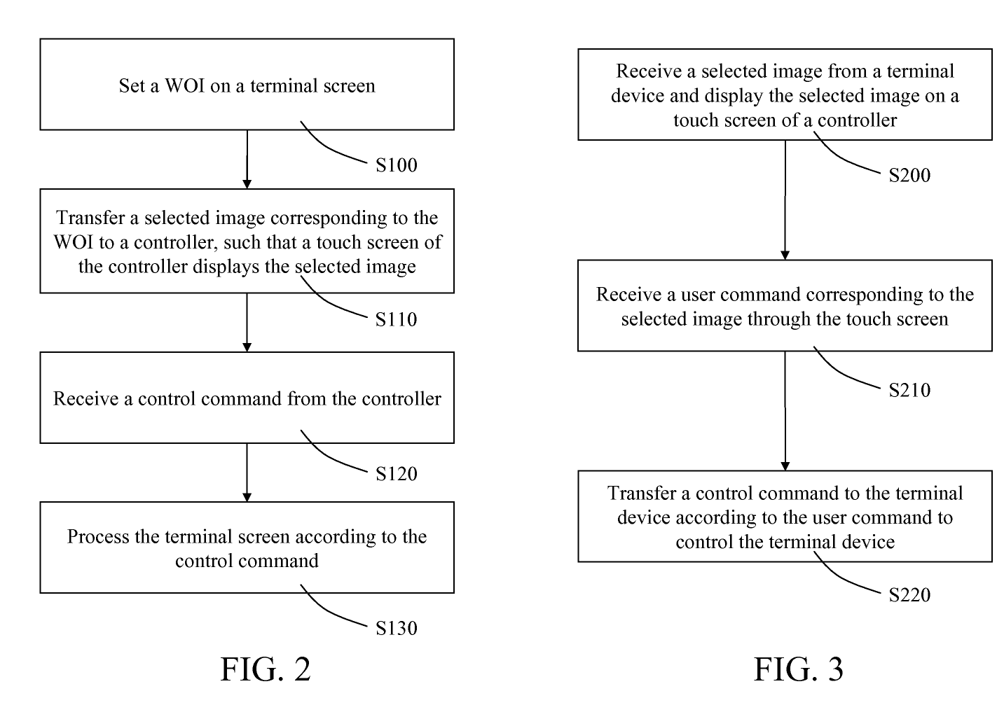

FIG. 2 is a flow chart of an image based processing method according to an embodiment. Referring to FIG. 2 together with FIG. 1, the image based processing method is executed on the terminal device 20. Firstly, the terminal device 20 sets a window-of-interest (WOI) 24 on the terminal screen 22 (Step S100). Next, a selected image corresponding to the WOI 24 is transferred to the controller 30, such that the touch screen 32 of the controller 30 displays the selected image (Step S110). The selected image refers to a part of the frame image in the WOI 24 in the entire frame of the terminal screen 22.

It can be seen from FIG. 1 that, the touch screen 32 only displays a part of the frame selected by the WOI 24. An aspect ratio of the WOI 24 may be set to be the same as that of the touch screen 32, and the controller 30 may automatically enlarge or reduce the selected image to have the same resolution as the touch screen 32, so as to be convenient for the user to view. However, the user may also display the selected image by using a scroll bar on the touch screen 32. It should be noted herein that, the WOI 24 may be frame lines obviously displayed on the terminal screen 22 or virtual frame lines not obviously displayed on the terminal screen 22.

The terminal device 20 receives a control command from the controller 30 (Step S120), in which the control command is corresponding to a user command received by the controller 30 through the touch screen 32. In other words, the user inputs the user command through the touch screen 32, and the controller 30 transfers the control command to the terminal device 20 according to the user command. Next, the terminal device 20 processes the terminal screen 22 according to the control command (Step S130). Step S120 and Step S130 may also be repeatedly performed continuously in order to perform the processing in response to the control of the user. Content of the user command, content of the control command, and a processing method of the terminal device 20 are described in detail hereinafter.

FIG. 3 is a flow chart of an image based control method according to an embodiment. Referring to FIG. 3 together with FIG. 1, the image based control method is executed on the controller 30. The controller 30 receives the selected image from the terminal device 20 and displays the selected image on the touch screen 32 of the controller 30 (S200), in which the selected image is corresponding to the WOI 24 of the terminal screen 22 of the terminal device 20. The controller 30 receives the user command corresponding to the selected image through the touch screen 32 (Step S210); and transfers the control command to the terminal device 20 according to the user command (Step S220), to control the terminal device 20. Step S210 and Step S220 may also be repeatedly performed continuously, for performing the processing in response to the control of the user.

The so-called “image based” in the image based control method and the image based processing method refers to a simple and intuitive control way provided through the selected image and the touch screen 32. The user may look at the selected image and the touch screen 32 and deliver the user command according to demands, to control the terminal device 20.

The user command may be a click command, a move command, a reducing command, or an enlarging command. The user may input the user command through various gestures, and the touch screen 32 detects the different gestures as different user commands, in which the gestures serving as the user commands are not limited. Furthermore, although the web browser is taken as an example of the application program of the terminal device 20 in this specification, in fact, the image based control method and the processing method may also control other application programs, and the present invention is not limited to the web browser.

For example, when the terminal device 20 executes the web browser, while the user intends to open a hyperlink in a web page, the user can click the position corresponding to the hyperlink of the web page in the selected image displayed on the touch screen 32 as the click command. The controller 30 can know the clicked position of the touch screen 32, and take a click coordinate of this position as a control command, and transfer the control command to the terminal device 20. The terminal device 20 knows which position in the entire frame of the terminal screen 22 is selected according to the click coordinate and the position of the WOI 24 on the terminal screen 22, and opens a corresponding click hyperlink. For example, when the terminal device 20 executes an application program of VOD or a game, the user may click the selected image displayed on the touch screen 32 to control an object on the terminal screen 22.

When the user intends to move the WOI 24 to view other parts of the frame (that is, to capture the image) through the controller 30, the user may slide a finger or a stylus on the touch screen 32, for serving as the move command. The controller 30 determines a moving direction according to the move command, and transfers the move command to the terminal device 20.

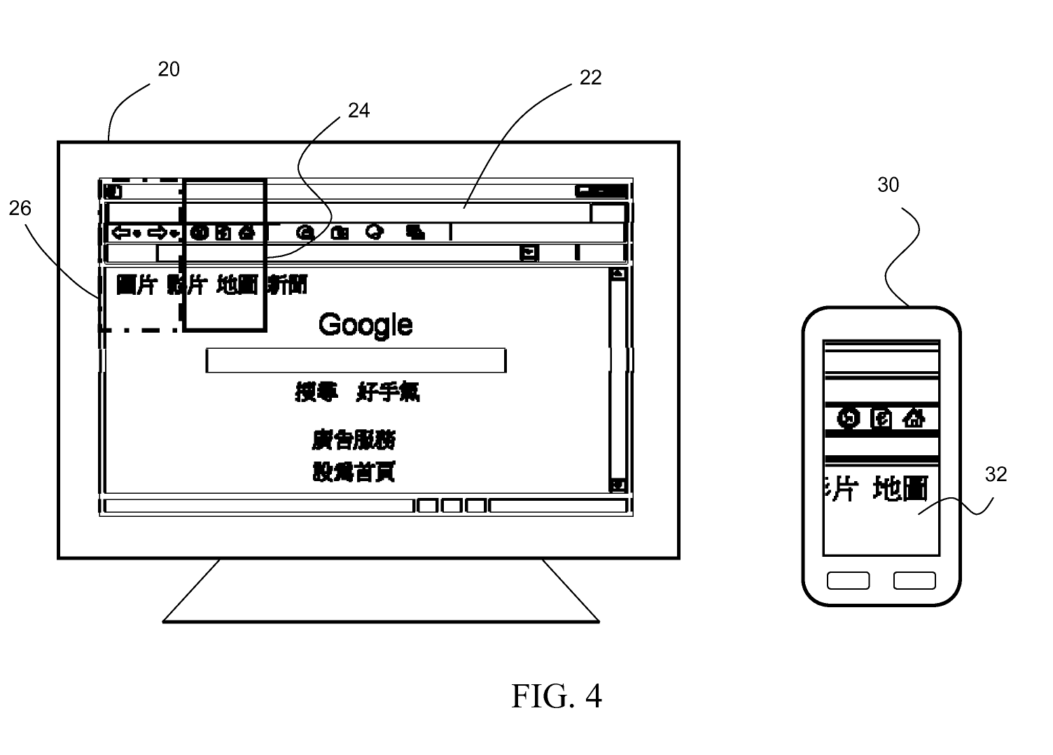

FIG. 4 is a schematic view of a moved WOI and a display according to an embodiment. For example, it may be defined that when the finger of the user slides over the touch screen 32 from right to left, the moving direction is towards right. The terminal device 20 moves the WOI 24 according to the moving direction, and then transfers the selected image corresponding to the moved WOI 24 to the controller 30. Thus, the controller 30 may receive a new selected image and display the new selected image on the touch screen 32. In FIG. 4, dashed lines represent an original WOI 26.

More particularly, an upper left corner of the terminal screen 22 may be defined as an origin of coordinates; when the moving direction is towards right, a horizontal ordinate of the original WOI 26 is added with a displacement to serve as the horizontal ordinate of the moved WOI 24. Similarly, no matter the user intends to move the WOI 24 towards up, down, left, or right, the user can freely control the position of the WOI 24.

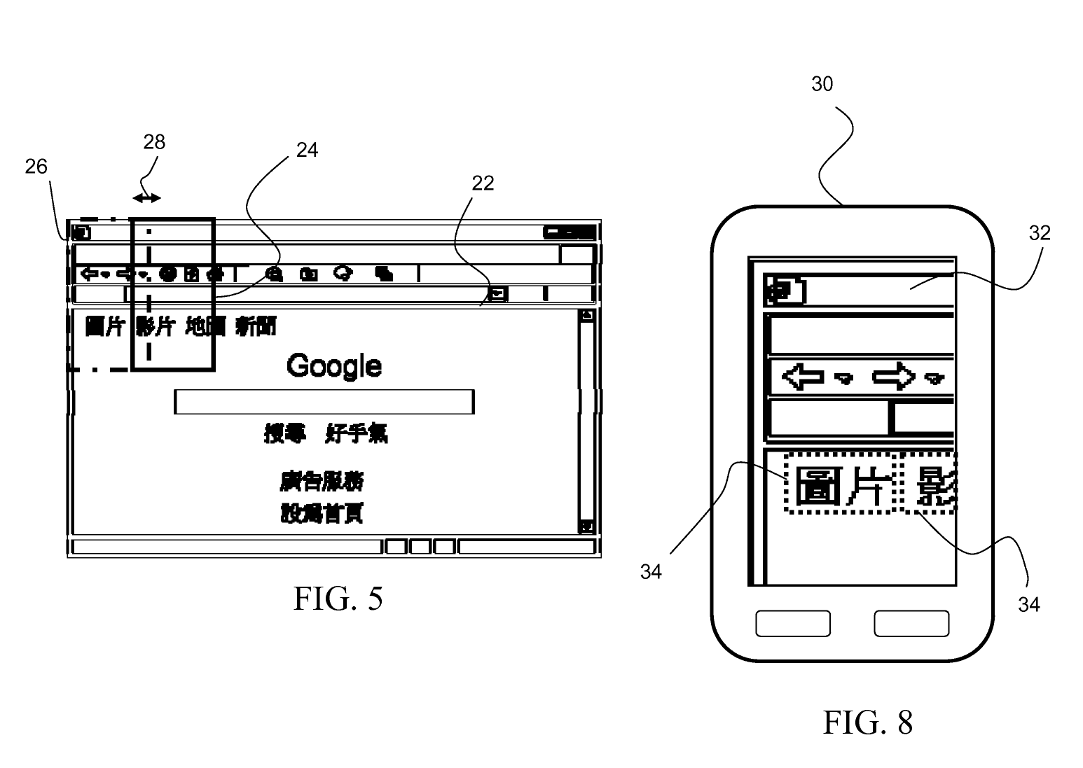

According to an embodiment, the original WOI 26 and the moved WOI 24 may partially overlap, as shown in FIG. 5. The original WOI 26 and the moved WOI 24 have an overlapped part 28, so as to avoid the generation of the hyperlink with the excessively small selection range. Furthermore, the controller 30 may also continuously transfer the moving direction to the terminal device 20 as the control command when detecting that the user inputs the move command and continuously presses an edge of the touch screen 32, such that the WOI 24 continuously moves towards the moving direction.

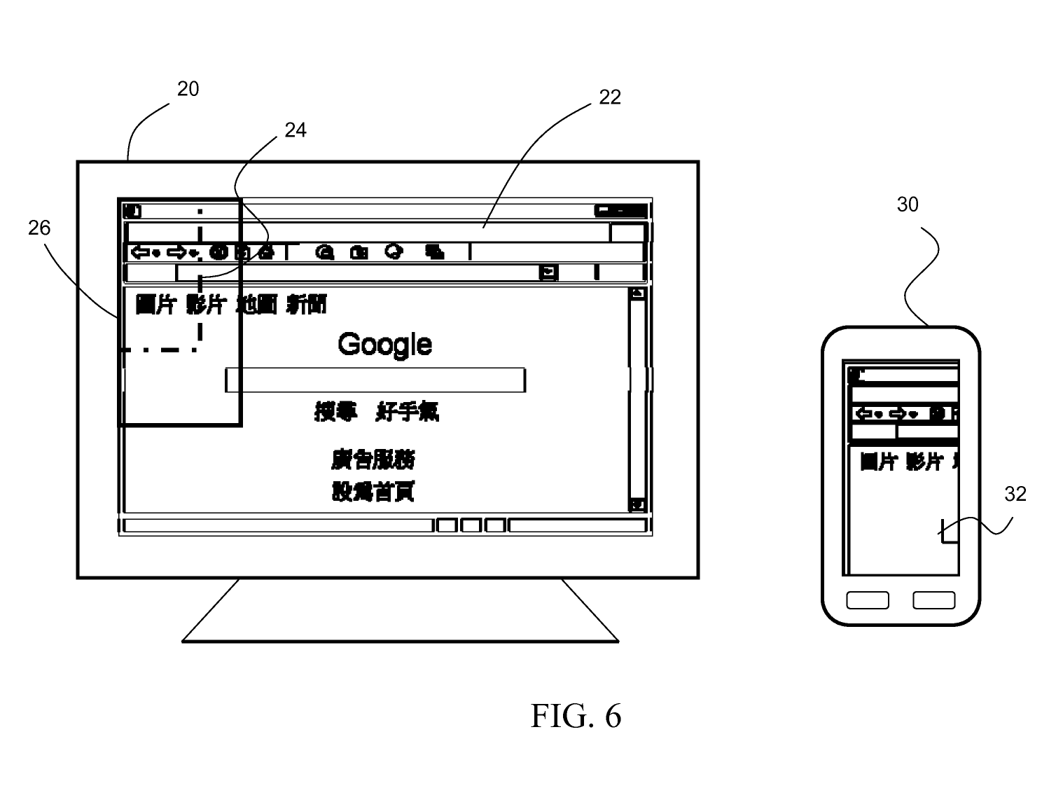

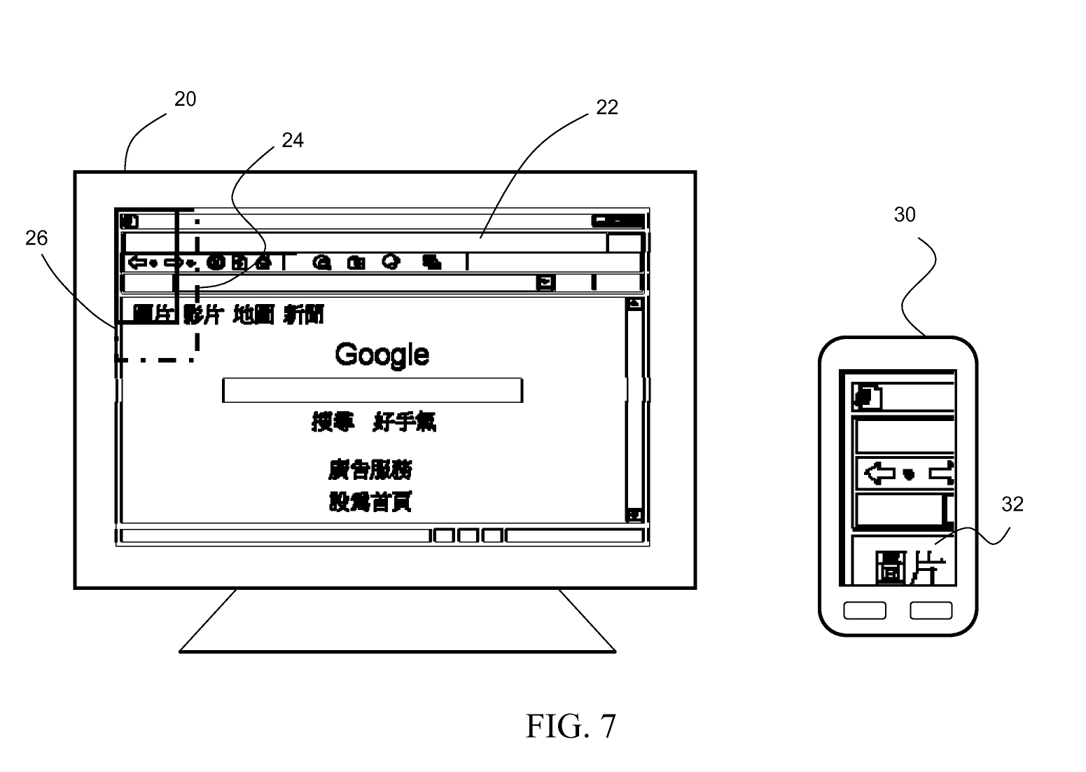

The user may also change the size of the WOI 24 of the terminal screen 22 through the reducing command or the enlarging command. FIG. 6 is a schematic view of an enlarged WOI and a display according to an embodiment, and FIG. 7 is schematic view of a reduced WOI and a display according to embodiment.

After receiving the reducing command, the controller 30 sends out a signal representing the reducing command as the control command to the terminal device 20. The reducing command represents that the user may intend to reduce the content of the selected image, to obtain more content. As shown in FIG. 6, the terminal device 20 enlarges the WOI 24 according to the reducing command, to obtain the selected image with reduced content. The terminal device 20 transfers the selected image with reduced content corresponding to the enlarged WOI 24 to the controller 30, and the controller 30 receives and displays the selected image with reduced content on the touch screen 32.

Similarly, after receiving the enlarging command, the controller 30 sends out the signal representing the enlarging command as the control command to the terminal device 20. The enlarging command represents that the user may intend to enlarge the selected image, to view the detailed content in the selected image. As shown in FIG. 7, the terminal device 20 reduces the WOI 24 according to the enlarging command, to obtain the selected image with enlarged content. The terminal device 20 transfers the selected image with enlarged content corresponding to the reduced WOI 24 to the controller 30, and the controller 30 receives and displays the selected image with enlarged content on the touch screen 32.

Besides the click command, the move command, the reducing command, and the enlarging command described above, the user command may also comprise commands of other types, for example, a command of simulating clicking a right-button of the mouse to call out the menu or dragging a cursor to perform WOI select.

Furthermore, according to an embodiment, when the terminal device 20 opens a web browser, besides the selected image, the terminal device 20 may also transfer a markup language information corresponding to the WOI 24 to the controller 30. The controller 30 receives and displays the markup language information on the touch screen 32. The markup language information may comprise at least one hyperlink tag, and may also comprise tags of other web elements. The hyperlink tag may be, for example, <a href=“http://www.tipo.gov.tw”>.

The markup language information may be considered as a small web page corresponding to the WOI 24 generated by the terminal device 20 according to the web browser, the web page content viewed by the user, and the WOI 24. The markup language information may be generated to satisfy a format, such as Hypertext Markup Language (HTML), Extensible Markup Language (XML), or Standard Generalized Markup Language (SGML). Accordingly, the controller 30 may have a browser to analyze the received markup language information and related necessary data, and display them on the touch screen 32 in cooperation with the selected image. Thus, the controller 30 can present the web page elements capable of interacting with the user, such as, the hyperlink tag or a drop-down menu in a web page, so as to provide a more intuitive control mode.

When the touch screen 32 receives the click command, together with the markup language information, the controller 30 may obtain which tag of the markup language information is clicked. Next, the controller 30 transfers the clicked tag to the terminal device 20 for being processed. Therefore, when the user clicks one of the hyperlink tags, the controller 30 can command the terminal device 20 to open the corresponding click hyperlink according to the clicked hyperlink tag.

Furthermore, it may be sometimes difficult for the user to determine whether a hyperlink exists merely according to the selected image, so the touch screen 32 can further display the hyperlink tag through a highlighted mark, as shown in FIG. 8. The browser of the controller 30 may use, for example, base lines, text with different colors, text with different sizes or patterns, outer frames, or changed base colors of text blocks as the highlighted mark 34.

In view of the above, the controller in the image based control system is a single controller and provides the touch screen with excellent operation performances and a wide application range. As compared with conventional controllers, the controller in the present invention omits the mouse or the multitudinous keys. Moreover, through various user commands, the image based control method, the processing method, and the system enable the user to manipulate the terminal device in a simple and easy way through the touch screen of the controller. The method of transferring the selected image and the markup language information and building a simple browser in the controller further enables the user to intuitively use the functions of the web browser of the terminal device.

What is claimed is:

1. An image based control method, applicable to a controller to control a terminal device, and comprising:
receiving a selected image and displaying the selected image on a touch screen of the controller, wherein the selected image is corresponding to a window-of-interest (WOI) of a terminal screen of the terminal device;
receiving a user command corresponding to the selected image through the touch screen; and
transferring a control command to the terminal device according to the user command, to control the terminal device.

2. The image based control method according to claim 1, wherein the user command comprises a click command, the control command comprises a click coordinate corresponding to the selected image, and the image based control method further comprises:
letting the terminal device open a click hyperlink according to the click coordinate.

3. The image based control method according to claim 1, wherein the user command comprises a move command, the control command comprises a moving direction, and the image based control method further comprises:
letting the terminal device move the WOI according to the moving direction; and
receiving the selected image corresponding to the moved WOI, and displaying the moved selected image on the touch screen.

4. The image based control method according to claim 3, wherein images corresponding to the WOI and the moved WOI partially overlap.

5. The image based control method according to claim 1, wherein the user command comprises a reducing command, and the image based control method further comprises:
letting the terminal device enlarge the WOI according to the reducing command, to obtain the selected image with reduced content; and
receiving the selected image with reduced content corresponding to the enlarged WOI, and displaying the selected image with reduced content on the touch screen.

6. The image based control method according to claim 1, wherein the user command comprises an enlarging command, and the image based control method further comprises:
letting the terminal device reduce the WOI according to the enlarging command, to obtain the selected image with enlarged content; and
receiving the selected image with enlarged content corresponding to the reduced WOI, and displaying the selected image with enlarged content on the touch screen.

7. The image based control method according to claim 1, further comprising:
receiving a markup language information corresponding to the WOI, and displaying the markup language information on the touch screen, wherein the markup language information comprises at least one hyperlink tag.

8. The image based control method according to claim 7, wherein the user command is a click command, the control command comprises the clicked hyperlink tag, and the image based control method further comprises:
letting the terminal device open a click hyperlink according to the clicked hyperlink tag.

9. The image based control method according to claim 7, wherein the touch screen displays the hyperlink tag through a highlighted mark.

10. An image based processing method, applicable to a terminal device with a terminal screen, and comprising:
setting a WOI on the terminal screen;
transferring a selected image corresponding to the WOI to a controller, such that a touch screen of the controller displays the selected image;
receiving a control command, wherein the control command is corresponding to a user command received by the controller through the touch screen; and
processing the terminal screen according to the control command.

11. An image based control system, comprising:
a terminal device, comprising a terminal screen, having a WOI set on the terminal screen, and transferring a selected image corresponding to the WOI; and
a controller, comprising a touch screen, receiving the selected image from the terminal device, displaying the selected image on the touch screen, receiving a user command corresponding to the selected image through the touch screen, and transferring a control command to the terminal device according to the user command, to control the terminal device;
wherein after receiving the control command, the terminal device processes the terminal screen according to the control command.

12. The image based control system according to claim 11, wherein the user command comprises a click command, the control command comprises a click coordinate corresponding to the selected image, and the terminal device opens a click hyperlink according to the click coordinate.

13. The image based control system according to claim 11, wherein the user command comprises a move command, the control command comprises a moving direction, the terminal device moves the WOI according to the moving direction, and the controller receives the selected image corresponding to the moved WOI, and displays the moved selected image on the touch screen.

14. The image based control system according to claim 13, wherein the WOI and the moved WOI partially overlap.

15. The image based control system according to claim 11, wherein the user command comprises a reducing command, the terminal device enlarges the WOI according to the reducing command to obtain the selected image with reduced content, and the controller receives the selected image with reduced content corresponding to the enlarged WOI, and displays the selected image with reduced content on the touch screen.

16. The image based control system according to claim 11, wherein the user command comprises an enlarging command, the terminal device reduces the WOI according to the enlarging command to obtain the selected image with enlarged content, and the controller receives the selected image with enlarged content corresponding to the reduced WOI, and displays the selected image with enlarged content on the touch screen.

17. The image based control system according to claim 11, wherein the controller further receives a markup language information corresponding to the WOI through the terminal device, and displays the markup language information on the touch screen, wherein the markup language information comprises at least one hyperlink tag.

18. The image based control system according to claim 17, wherein the user command is a click command, the control command comprises the clicked hyperlink tag, the terminal device opens a click hyperlink according to the clicked hyperlink tag, and the touch screen displays the hyperlink tag through a highlighted mark.
